(19) United States
(12) Patent Application Publication
(10) Pub. No.: US 2006/0199692 A1
(43) Pub. Date: Sep. 7, 2006

(54) Gear drive

(76) Inventor: Bartolomej Janek, Presov (SK)

Correspondence Address: HORST M. KASPER, 13 FOREST DRIVE, WARREN, NJ, 07059, US

(21) Appl. No.: 11/072,820

(22) Filed: Mar. 4, 2005

(51) Int. Cl. F16H 1/32

(52) U.S. Cl. 475/162

(57) ABSTRACT

The Invention relates to a gear drive with at least one wheel with internal toothing, with at least one output member rotatably supported relative to the wheel as well as an input shaft with at least one eccentric section with an eccentricity, wherein the wheel with external toothing combs in the internal toothing and is rotatably supported on the eccentric section, wherein in case of two output or members at least one wheel is disposed between the output members, as well as having a facility disposed between the wheel and the output member, wherein the facility transforms the planetary motion of the wheel into a rotary motion of the output member, wherein the facility exhibits at least one cylindrical body extending in the axial direction of the wheel, wherein the cylindrical body is supported rotatably in the device, wherein the cylindrical body is connected operationally to the wheel or, respectively, to the output member, wherein the device is rotatably supported in an opening of the output member or, respectively, of the wheel, and wherein the axis of the body is disposed at a distance corresponding to the eccentricity from the axis of the opening.

### BACKGROUND OF THE INVENTION

1. Field of the Invention

The Invention relates to a gear drive with the least one wheel (40) with an internal toothing, with at least one output member rotatably supported relative to the wheel with internal toothing as well as an input shaft with at least one eccentric section, wherein a wheel with external toothing is rotatably supported on the input shaft and combs with the internal toothing, as well as with a facility disposed between the wheel having the external toothing and the output member, and wherein the facility transforms a planetary motion of the wheel with the external toothing into a rotary motion of the output member.

2. Brief Description of the Background of the Invention Including Prior Art

The two-stage gear drive is known from U.S. Pat. No. 4,348,918. The first stage comprises a first wheel and a second wheel with an external toothing engaging into each other, wherein the second wheel is connected fixed against rotation to a crankshaft. The second stage comprises a carrier body having internal toothing, wherein the internal toothing of the carrier body combs with the external toothing of the wheels of the first stage. The wheels with the external toothing are furnished with openings, wherein the wheels with external toothing are rotatably supported on the crank parts of the crankshaft in the openings. The carrier body is rotatably supported on output members fixedly connected to each other, wherein the output members are furnished with openings and wherein the ends of the crankshaft are rotatably supported in the openings. The crankshaft represents a component transferring the drive power with regard to the functioning.

It is a disadvantage of the known gear drive that the crankshaft is rotatably supported on four bearings in openings of four different components. Such a multiple bearing of the crankshaft is undetermined, which means that the production tolerances of the openings, where the crankshaft is supported in the openings, are dependent on each other and have to be maintained sufficiently small, which renders production of the gear drive very complicated. An undesirable increase of the running noise, vibrations, and the premature damaging of the gear drive can occur as a consequence of possibly different production tolerances.

In general each gear drive is equipped with more than one crankshaft for securing a sufficient power capacity. The production of the gear drive is extremely costly because of the high requirements relative to the production tolerances and because of the number of crankshafts in the gear drive. Similarly also the assembling of the facility is complicated because of the required mutual tuning of the production tolerances of the individual parts. The complicated shape of the crankshaft does not render possible the use of a powerful technology known from the mass production of bearings, and a simultaneous working of several crankshafts is also not possible.

The surface of the parts of the crankshaft disposed eccentricly relative to each other is the most stressed surface of the complete gear drive with respect to fatigue. A consideration by the eye or an inspection of the surfaces of the parts of the crankshaft disposed eccentricly relative to each other presupposes a disassembly of the complete gear drive. This renders the operation and the maintenance of such gear drives complex and expensive. In most cases the crankshaft has to be replaced in case of a damage, wherein the crankshaft is particularly important relative to the production costs.

The rotatable support of the carrier body on the output member pair is furnished inside, which limits the inner chamber of the gear drive in a radial direction. The components disposed in the interior of the gear drive can-as a consequence be dimensioned only small and not sufficiently rugged which again limits the power data of the gear drive, for example the maximum torque, the maximum power, the torsional stiffness, and so on.

### SUMMARY OF THE INVENTION

1. Purposes of the Invention

Starting from the above recited state-of-the-art it is an object of the present Invention to furnish a remedy here.

These and other objects and advantages of the present invention will become evident from the description which follows.

2. Brief Description of the Invention

The object is accomplished by providing that the facility exhibits at least one cylindrical body extending in axial direction of the wheel with external toothing, wherein the cylindrical body is rotatably supported in the device, wherein the body is operationally connected to the wheel having external toothing or, respectively, to the output member, wherein the device is rotatably supported in the opening of the output member or, respectively, of the wheel having external toothing, and wherein the axis of the body maintains the distance from the axis of the opening corresponding to the eccentricity.

It is essential in connection with the gear drive according to the present Invention that the facility is disposed between the wheel with the external toothing and the output member, wherein the facility transforms the planetary motion of the wheels with external toothing into a rotary motion of the output member. The gear drive according to the present Invention is characterized by having the facility formed out of at least one cylindrical body, wherein the cylindrical body is oriented in the direction of the axis of the wheel with internal toothing, wherein the cylinder shaped body is functionally connected to the wheel with the external toothing or, respectively, to the output member. The cylinder shaped body usually is formed as a tenon with a circular cross-section and is connected to the wheel with external toothing.

The wheel with external toothing is here rotatably supported on the eccenter. The wheel with external toothing exhibits for this purpose a central opening, wherein the eccenter can be slipped into the central opening.

The wheel with the external toothing disposed on the rotating eccenter runs in the inner gear rim of the internally toothed wheel and thereby performs a superposed rotary and eccenter motion.

It is here a core of the Invention that this superposed motion can be transformed directly into a rotary motion of the output member and therewith of the output shaft with the aid of a device, which device is part of the transformation facility.

It is an advantage of the gear drive according to the present Invention that the facility transforming the planetary motion of the wheel can be produced out of components having an uncomplicated shape, wherein the components can be produced by way of highly productive technologies employed in the production of bearings, whereby a substantial decrease of the production costs relative to the state-of-the-art can be accomplished.

The cylinder shape body is formed in this manner preferably by a tenon having a circular cross-section, wherein the tenon can be produced out of a semi finished rod and can be ground on highly productive centerless circular grinding machines. In the same fashion the device comprises preferably an eccentric ring, wherein the inner face axis of the eccentric ring is offset relative to the outer face axis by a distance, which distance corresponds to the eccentricity. The outer face of the eccentric ring can be generated by highly productive centerless grinding and the front faces can be generated by highly productive grinding employed during the grinding of the bearing ring front faces.

A multiple production process can be employed during the turning and grinding of the eccentric ring inner face, wherein several eccentric rings are simultaneously turned and ground during the production process. An advantage of a simultaneous grinding of inner faces of several eccentric rings comprises that each ring is milled with the same eccentricity, which represents the precondition for a uniform and quiet running of the gear drive.

It is a particular property of the gear drive according to the present Invention that in the case of the damaging or of a required consideration by the eye of the facility transforming the planetary motion of the wheel, then the facility can be demounted without the necessity of a demounting of the complete gear drive.

An additional advantage of the gear drive according to the present Invention comprises that the power can be transferred through two transfer paths independent from each other, wherein each of the two paths comprises the wheel with external toothing, a transformation facility and an output member. This construction renders an operation of the gear drive possible even without the mutual, fixed connection of the output members. In addition difficulties are eliminated, which are a consequence of the mutual influencing of the tolerances of the bearing of the transformation facility and which difficulties have been discussed already in the state-of-the-art.

At least one wheel with external toothing is supported here between the selected output members connected to each other. The connection of the output members can for example be realized by least one cross member, wherein the cross member is such guided with a play through the axial opening of the wheel with external toothing such that the two output members form a pair mutually not rotatable relative to each other. The cross member forms either an integral component of at least one of the output members or the cross member is formed as a self-contained component at least fixedly connected to an output member. A threaded bore hole and a bore hole for a screw and for a peg can be furnished at the front side of the cross member and the output members are fixedly connected with the aid of the screw and the peg.

The output members are fixedly connected to each other as desired and are here preferably rotatably supported in or at the wheel with the internal toothing. The wheel with the internal toothing combs with the wheel with the external toothing. The internal toothing can be formed by cogs having a circular cross section, wherein the cogs are inserted into grooves having a semi circular formed cross-section. The axis of the wheel with external toothing is offset by a distance corresponding to the eccentricity relative to the axis of the wheel with the internal toothing. An advantageous construction and embodiment of the Invention furnishes that the parts of the apparatus can be connected shape matchingly to each other.

An advantageous embodiment of the Invention provides that the tenon shaped body disposed at a distance relative to the longitudinal axis of the input shaft, protrudes into the opening at the output member or at the wheel.

An advantageous embodiment of the Invention provides that the device is formed of a hollow cylinder shape.

An advantageous embodiment of Invention provides that the device shows the shape of a sleeve, wherein the sleeve fills the space between the tenon and the opening without play.

Another advantageous embodiment of the Invention furnishes that the outer envelopment and the inner envelopment of the device formed cylindrically, wherein the axis of the opening coincides with the axis of the outer face of the device and wherein the distance of the axis of the outer face of the device relative to the axis of the cylindrical inner envelopment corresponds to the eccentricity.

The device here exhibits preferably the shape of a ring having an inner face and having an outer face, wherein the axis of the inner face is offset relative to the axis of the outer face by a distance, wherein the distance corresponds to the eccentricity. Such a shape is also designated as an eccentric ring. The device can thus balance the eccentric motion component of the combined rotary and eccenter motion of the wheel with external toothing, which motion component also the cylindrical body performs, wherein the cylindrical body is supported in the device and fixedly connected to the wheel with the external toothing. The device is here rotary supported both relative to the cylinder shape body as well as relative to the opening. The rotary support of the device in the off center opening of the output member is either a roller bearing or a sliding bearing, and the rotary support of the cylinder shape body in the device is also a roller bearing or a sliding bearing.

Another advantageous embodiment of the Invention provides that several, preferably two, three, four, five, or six bodies are furnished, wherein the bodies are distributed around the longitudinal axis of the input shaft and are connected operationally to a corresponding number of devices. Loadings of individual parts of the gear drive in particular with respect to the face of the hole and the bearing load can be reduced by the employment of several bodies and devices for transforming the combined rotary and eccentric motion of the wheel with external toothing into a rotary motion of the output member.

A further advantageous embodiment of the Invention provides that the axial length of the bodies as well as the axial length of the device is selected such that the axial length approximately corresponds to the thickness of the output member.

An additional advantageous embodiment of the Invention furnishes that the connection between the bodies and the coordinated devices can be furnished by plug connections in axial direction.

An additional advantageous embodiment of the Invention provides that at least an axial roller bearing is disposed between the planar parallel front faces of the output member and of the wheel, wherein the output member and the wheel are mutually supported through the axial roller bearing. In addition, a particularly compact and rugged construction of the gear drive can be accomplished in this manner.

An additional advantageous embodiment of the Invention provides that the device exhibits the shape of an eccentric ring shaped sleeve and is disposed in the space between the body and the opening, wherein between the body and the device and/or between the device and the opening there is disposed in each case a roller bearing.

Another particularly advantageous embodiment of the Invention furnishes that the eccentric section of the input shaft comprises at least one cylinder shaped crank pin parallel displaced by the eccentricity relative to the longitudinal axis of the input shaft, wherein the diameter of the crank pin corresponds at least to the diameter of the drive shaft plus twice in the value of the eccentricity. Here the crank pin forms the track for roller bodies disposed between the crank pin and the wheel with external toothing. By constructing the crank pin with a diameter corresponding to at least the diameter of the input shaft plus the doubled eccentricity, the input shaft and the crank pin can be produced of a single piece. The drive shaft can be pulled in into the gear drive as a single piece and can be pulled out of the gear drive in a single piece. If two or more crank pins are furnished, then these crank pins are disposed uniformly staggered relative to each other over the circumference of the input shaft.

The essence of the Invention gear drive comprises here that the input shaft is furnished with at least an eccentric part, and preferably with a crank pin. In the case of two eccentric parts, these eccentric parts are rotated relative to each other mutually by 180 degrees or approximately 180 degrees. The axis of the crank pin is offset relative to the axis of the input shaft by a distance, wherein the distance corresponds to the eccentricity of the crank pin.

It is important here that the crank pin together with the input shaft can be produced relatively simple as a rotary part instead of the expensive production of a crank shaft, where the crank sections staggered relative to each other are produced by forging and are connected to each other. The input shaft and the crank pin exhibit a common jacket face, wherein the input shaft eccentricly penetrates the crank pin. In contrast in connection with a crank shaft, the input shaft and the crank section do not exhibit a common jacket face and the input shaft runs at least in part outside of the crank section.

An additional, particularly advantageous embodiment of the Invention furnishes that the input shaft exhibits at least one section with an external toothing, wherein the external toothing combs a geared wheel connected to the device, wherein the axis of the geared wheel corresponds to the axis of the opening, in which opening the device is disposed. The device is rotated syncronously to the rotation of the input shaft by the geared wheel connected to the device and combing the external toothing of the input shaft. The eccentric offset between the cylinder shaped outer jacket and the cylinder shaped inner jacket of the sleeve shaped device is thereby rotated syncronously to the eccentric motion of the eccentric section of the input shaft. An additional degree of freedom for influencing the translation ratio of the gear drive is generated here.

Such a construction of the gear drive according to the present Invention exhibits all advantages of a gear drive with a central crankshaft. In addition the complete translation ratio can be changed with the aid of the translation ratio of the geared wheels and the wheels with external toothing engaging with each other.

The particular advantageous embodiment of the Invention provides that the output member is rotatably supported on the front side at the wheel with the internal toothing.

The wheel with internal toothing exhibits here cylinder shape radial internal faces and at the same time at least an axial circular ring face at a front outer side at the sides resting at the output member, wherein the axial circular ring face is directed and aligned perpendicular to the axis of the wheel with the internal toothing. The cross distance of the axial circular ring faces at the wheel with the internal toothing determine the thickness of the wheel with the internal toothing.

An advantage of the arrangement of the axial circular ring faces of the wheel with the internal toothing at the outer front side of the wheel with internal toothing comprises that this arrangement increases the inner space of the wheel in a radial direction with unchanged outer dimensions. The larger inner space makes possible a more rugged construction of the components of the gear drive, whereby the functional parameters of the gear drive such as for example the torque capacity, the power density, the torsional stiffness and others reach higher values opposite to the state of the art.

Here preferably cylinder shaped roller bodies are disposed in the space between the axial faces of the output member disposed toward each other and the wheel with the internal toothing, wherein the axes of the roller bodies are aligned perpendicular to the axis of the wheel with the internal toothing. The axial face of the output member and the axial face of the wheel with internal toothing can be arched correspondingly in order to eliminate edge tensions at the ends of the roller bodies, wherein the roller bodies are disposed between these faces. Similarly it is conceivable to employ balls. Bearing tracks for supporting the ball shaped or, respectively, barrel shaped roller elements can be formed at the axial faces resting against each other of the output member and the wheel with internal toothing.

The roller bodies between the resting axial faces of the output member and of the wheel with internal toothing are here advantageously supported in the recesses of the bearing cage furnished for this purpose. The bearing cage exhibits here at least a front face and an in inner face, wherein the bearing cage rests on the radial face of the output member with the inner face. Here the bearing cage is rotatably supported on the radial face of the output member. The recesses of the bearing cage are formed such that a radial falling out of the roller bodies from the bearing cage is prevented.

The diameter of the part circle of the roller bodies applied to the outer axial faces is also larger in comparison with the disposition of the roller bodies at the inner axial face. Consequently the value of the stiffness against tipping and the torque capacity increase substantially opposite to the present state of the art while maintaining equal outer dimensions of the gear drive.

Furthermore it belongs to the advantage of the rotary support of the output member according to the present Invention, that the difference of the circumferential speeds of the cage with the roller bodies is minimal on the roll faces of the output member, which is of advantage in view of the friction and the abrasion of the bearing cage.

The arrangement of the roller running paths at the front sides of the wheel with internal toothing shows several important advantages:

1. The grinding of the tracks disposed at the front sides of the wheel with internal toothing can be performed on highly productive grinding machines employed in the production of bearings, which substantially reduces the production costs.

2. The tracks exposed at the front sides of the wheel with the internal toothing serve simultaneously as inside recesses for the grinding of the internal toothing, thus the requirement of an additional technical clamping surface can be dispensed with, which also reduces the production costs.

3. The measurement of the distance of the tracks disposed at the front sides of the wheel with the internal toothing for the purpose of adjusting a favorable axial pretension of the roller bearing of the output members is also simplified.

Roller bodies of cylindrical shape, wherein the axes of the roller bodies are aligned parallel to the axis of the wheel with internal toothing, can be disposed between the radial face of the output member and the radial face of the wheel with internal toothing. Preferably here also a guiding of the roller bodies furnished by a bearing cage.

The radial face of the output member and the radial faces of the wheel with internal toothing can be correspondingly arched for eliminating the edge tensions at the ends of the roller bodies, which roller bodies are disposed between these faces.

Here again employment of balls is conceivable.

A particular advantageous embodiment of the Invention provides that at least bearing tracks for a roller bearing or a ball bearing are furnished at least at the axial faces of the output member and at the axial faces of the wheel with internal toothing disposed toward each other.

The novel features which are considered as characteristic for the invention are set forth in the appended claims. The invention itself, however, both as to its construction and its method of operation, together with additional objects and advantages thereof, will be best understood from the following description of specific embodiments when read in connection with the accompanying drawing.

### BRIEF DESCRIPTION OF THE DRAWING

The following description of the points illustrates one of the possible embodiments of the gear drive according to the present Invention.

There is shown in:

FIG. 1 a section B-B through a gear drive according to the present Invention guided through a cylinder shaped body and a cross member disposed at one of the output members,

FIG. 2 a perspective explosion view of the individual gear drive components in their mutual functional positions,

FIG. 3 a section C-C through the gear drive disposed in the plane of the front face of a wheel with external toothing,

FIG. 4 a section D-D through the gear drive led through the circular ring front face of the output member,

FIG. 5 a detailed view of the arrangement of the transformation facility of the gear drive, which transforms the planetary motion of the wheel with external toothing into a rotary motion of the output member,

FIG. 6 a section of the input shaft through the symmetry plane of the input shaft showing the position of the crank pin axis relative to the input shaft axis,

FIG. 7 an arrangement of the roller bodies in the bearing cage for supporting the output members,

FIG. 8 a partial view of the axial guiding of the wheel with external toothing,

FIG. 9 an example of the connection of the drive motor with the gear drive,

FIG. 10 a cross member being an element not integrated with the input member,

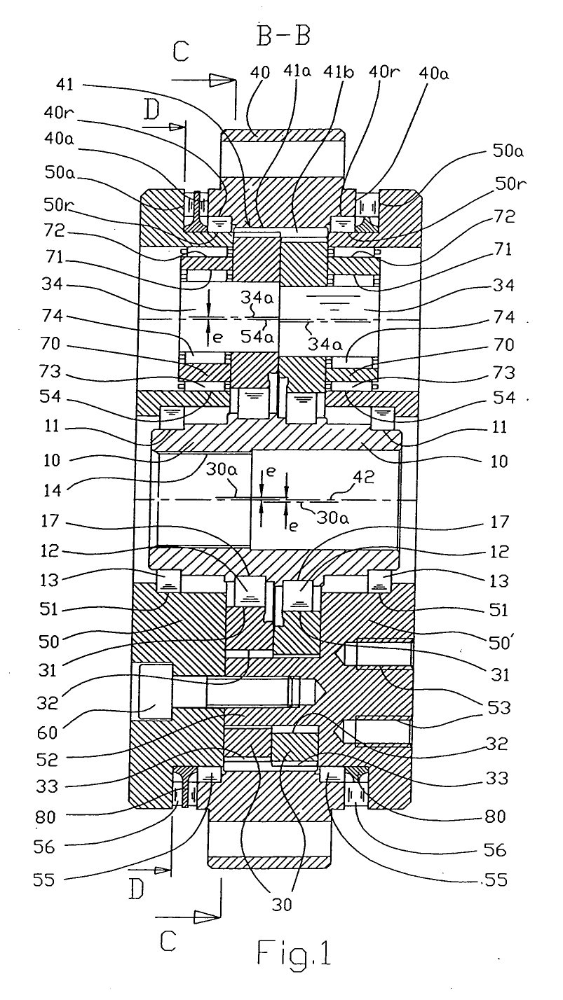

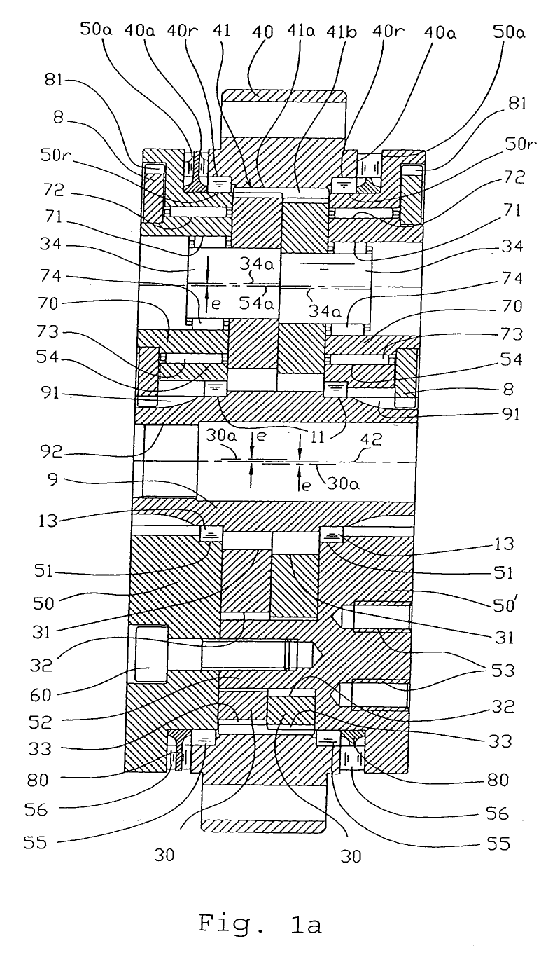

FIG. 1a a section through a gear drive according to the present Invention expanded by a second stage,

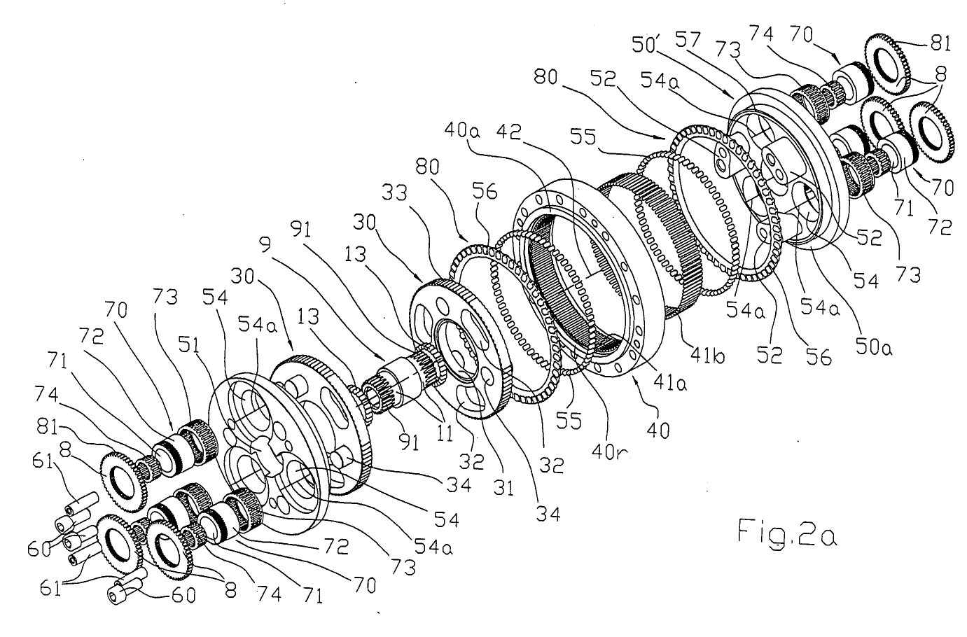

FIG. 2a a perspective explosion representation of the gear drive expanded by a second stage,

FIG. 2b a perspective detailed view of the transformation facility of the gear drive expanded by a second stage.

### DESCRIPTION OF INVENTION AND PREFERRED EMBODIMENT

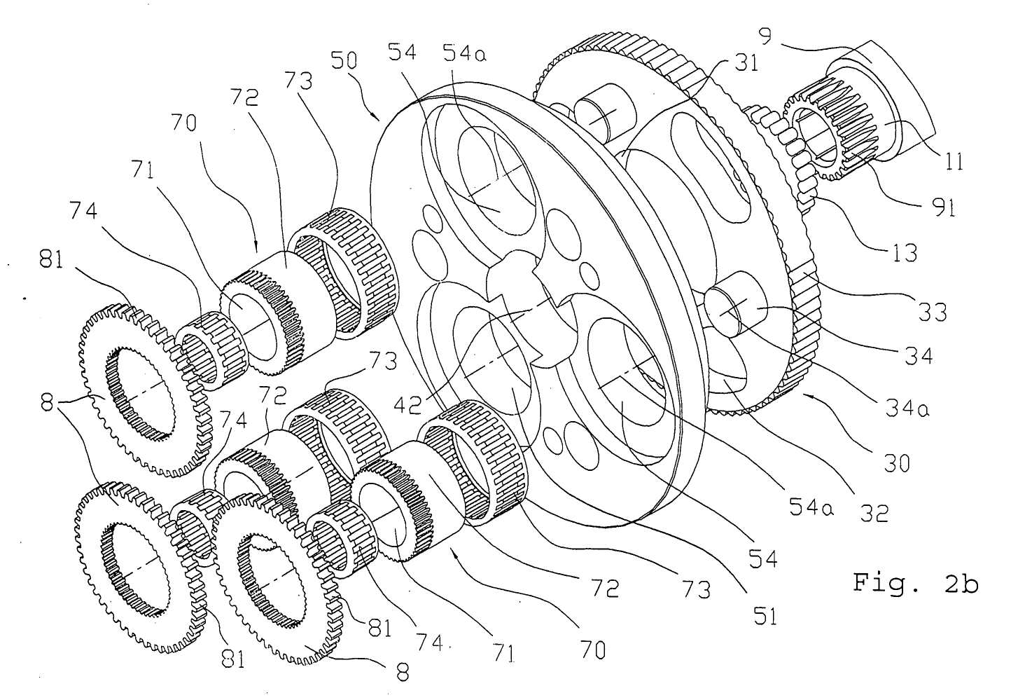

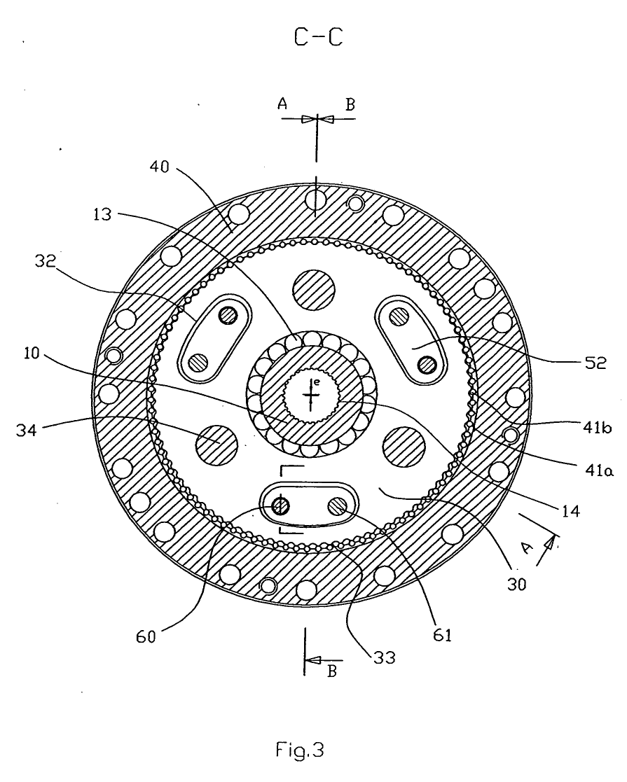

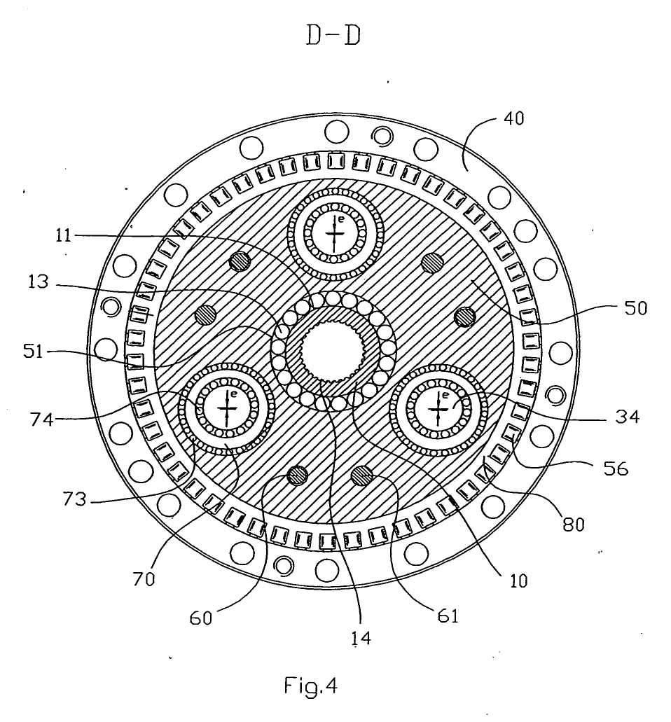

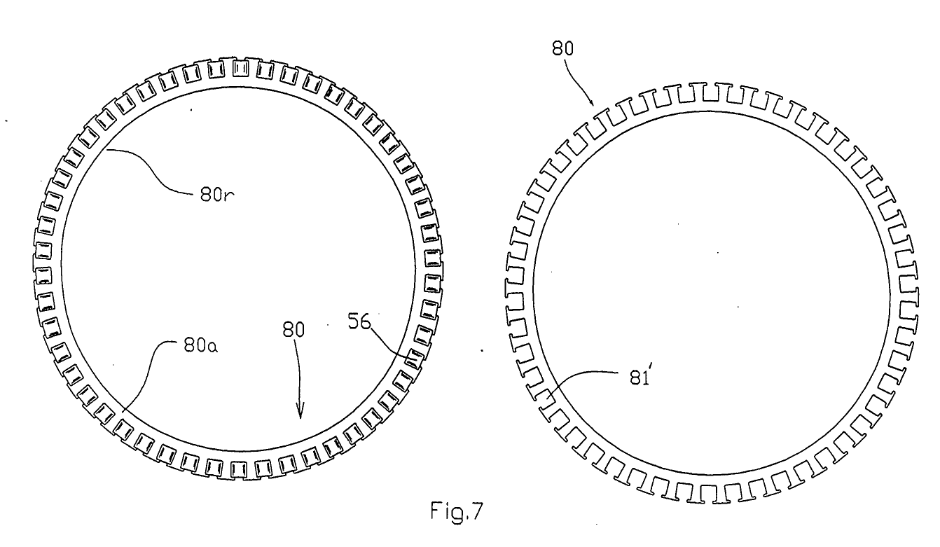

A first advantageous embodiment of the gear drive according to the present Invention is illustrated in the FIGS. 1 and 2 and in the supplementary FIGS. 3 to 10.

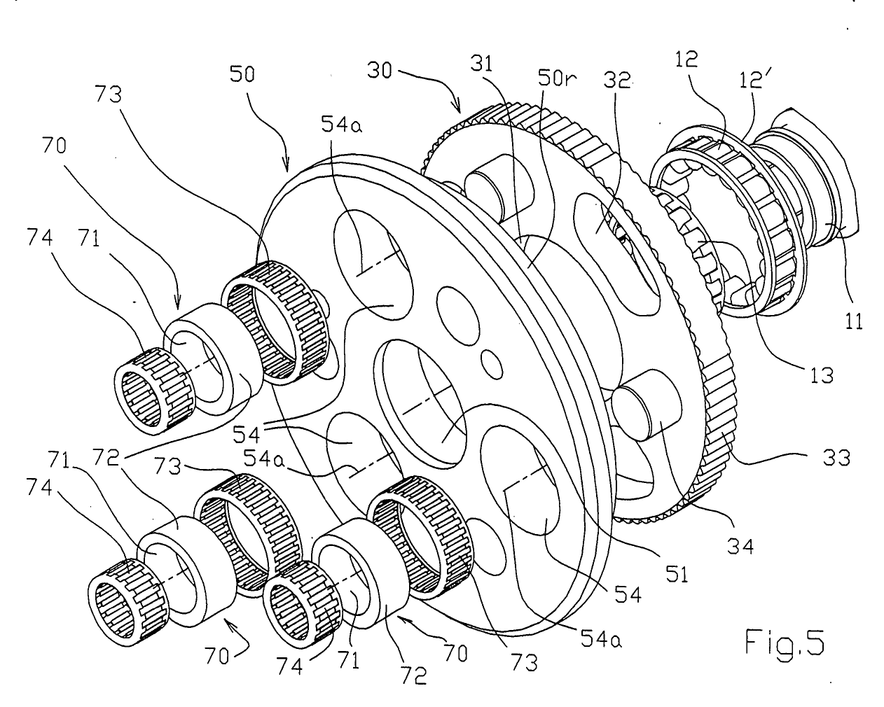

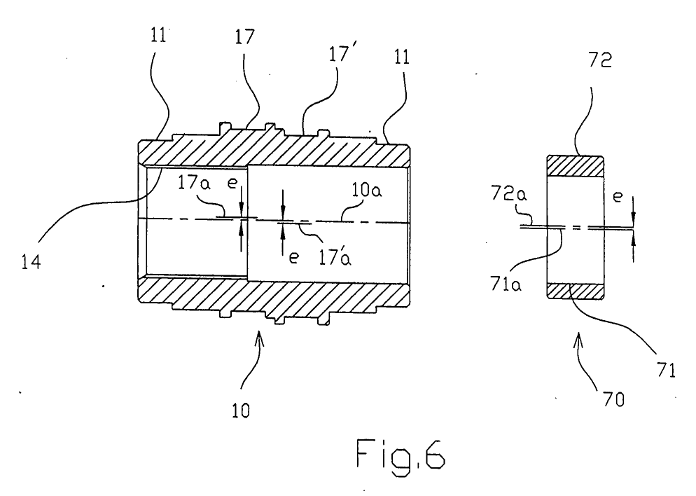

The input shaft 10 is furnished with a crank pin pair 17, 17′—the eccenters—, wherein the eccenters are disposed offset relative to each other by 180 degrees around the axis 10a of the input shaft. The axis 17a, 17′a of the crank pins 17, 17′ are offset by a distance e—the eccentricity—against the axis 10a one the input shaft. The input shaft 10 is furnished at the inner opening with an inner groove 14 for the connection of the drive motor (FIGS. 1 and 6).

Wheels 30 with external toothing 33 are rotatably supported on the eccenters 17,17′ through central openings 31, wherein the circumference of the eccenters 17, 17′ form tracks for the rolling elements 12. The rolling elements are supported in the bearing cage 12′. The wheels 30 with external toothing 33 engage into the internal toothing 41 of the wheel 40 (FIGS. 1 and 5).

The number of the teeth of the outer toothing 33 of the wheel 30 is smaller as the number of teeth of the inner toothing 41 of the wheel 40. The axis 30a of the wheels 30 is offset by the distance e opposite to the axis 42 of the wheel 40 (FIG. 1). The internal toothing 41 comprises grooves 41a having a semi circular profile, wherein cylinder cogs 41b are supported in the grooves 41a (FIGS. 2 and 3).

The wheels 30 with external toothing are furnished with off-centered passing through axial openings 32 at equal distances from each other at the outer circumference (FIGS. 1,2,3). The wheels 30 are disposed between the output members 50, 50′, wherein the output members 50,50′ are connected by way of cross members 52, wherein the cross members 52 traverse with a play the axial openings 32 of the wheels 30 such that the output members 50, 50′ form a pair free of mutual motion (FIGS. 1,2).

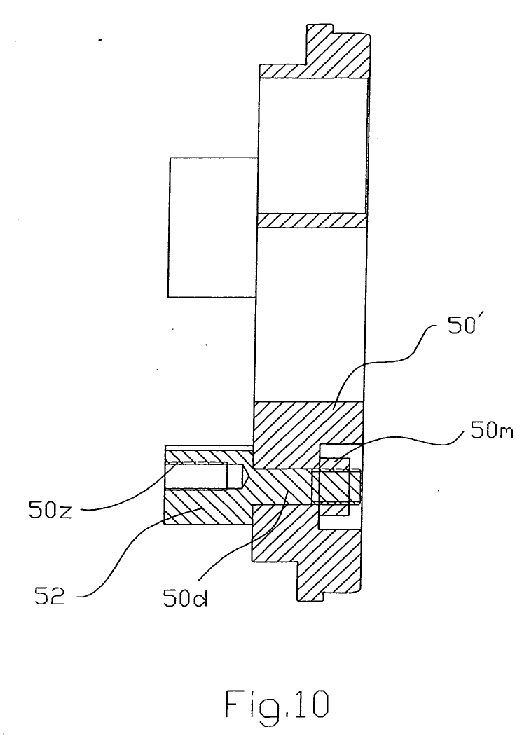

The cross members 52 represent an integral component of the output member 50′ (FIGS. 1,2). A threaded bore hole 58 for the screw 60 as well as a bore hole 59 for the pin 61 is performed at the front side of the cross member 52, wherein the screw 60 and the peg 61 solidly connect the output members 50, 50′ (FIGS. 1,2, and 3). The cross member 52 can be formed as an autonomous component fixedly connected at least to one output member 50,50′ (FIG. 10). The threaded bore hole 50z for the screw 60 and a bore hole for the peg 61 are disposed at the front side of the cross member 52, wherein the output members are connected solidly to each other with the aid of the screw 60 and of the peg 61 (FIG. 2). The cross member 52 has in this case a cylinder shaped part 50d with a thread disposed at one end of the cylinder shaped part 50d, wherein the cylinder shaped part 50d is furnished with a safety nut 50m (FIG. 10).

The solidly connected output member pair 50, 50′ is rotatably supported in the wheel 40. Each of the output members 50, 50′ is furnished with a central opening 51 having an outer cylindrical radial face 50r. The input member 10 is rotatably supported in the central openings 51 of the output members 50,50′ with the aid of rolling members 13 and bearing tracks 11 disposed at the ends of shaft 10. The rolling members 13 are supported in a bearing cage (FIGS. 1 and 2).

Off center openings 54 of the output members 50, 50′ attached at equal distances from each other at the outer circumference are disposed in the space between the central opening 51 and the radial face 50r of the output members 50, 50′.

The output members 50, 50′ at the outer side are furnished with off center axial faces 50a, and in fact at the side resting at the wheel 40.

The wheel 40 at the sides resting at the output member 50, 50′ is furnished with the cylindrical radial inner faces 40a and simultaneously the wheel 40 at the outer front sides is furnished with axial circular ring faces 40a wherein the axis of the wheel 40 with internal toothing 41 is perpendicular aligned to the axial circular ring faces 40a. The cross distance of the axial faces 40a at the wheel 40 with the internal toothing 41 determine the depth of the wheel 40 (FIGS. 1,2).

Roller members 56 in cylindrical shaped form are disposed at two sides between the axial faces 40a and 50a of the wheel 40 and, respectively, of the output member 50, 50′, wherein the axis of the roller members 56 is aligned perpendicular to the axis 42 of the wheel 40. The roller members 56 are supported in the recesses 81′ of the bearing cage 80, wherein the bearing cage 80 exhibits two front faces 80a and an inner face 80r, wherein the bearing cage 80 rests with the inner face 80r on the cylindrical outer face of the output member.

Cylinder shaped roller elements 55 are disposed between the radial outer faces 50r of the output members 50, 50′ and radial inner faces 40r of the wheel 40, wherein the axis of the cylinder shaped roller elements 55 is oriented in the direction of the axis 42 of the wheel 40 with internal toothing (FIGS. 1,2). The roller elements 55 are guided by one of the front faces 80a of the bearing cage 80 and of the guide face formed at the wheel 40 while rolling over the faces 50r and 40r (FIGS. 1,7).

A facility is disposed between each of the wheels 30 with external toothing 33 and the resting output member 50, 50′, wherein the facility transforms the planetary motion of the wheel 30 with external toothing 33 into a rotary motion of the output member 50, 50′. This facility comprises three cylinder shaped bodies 34 formed as cylindrical tenons, wherein the cylinder shaped bodies 34 are disposed on the front face of the wheel 30 resting at the output member 50, 50′ and are distributed uniformly over the circumference of the wheel 30. The cylinder shaped bodies 34 are oriented in the direction of the axis 42 of the wheel 40 with internal toothing and are solidly connected to the wheel 30 with external toothing. The cylinder shaped bodies 34 are supported rotatably at the devices 70, wherein the devices 70 in turn are rotatably supported in the off center openings 54 of the output members 50, 50′ (FIGS. 1,2). The device 70 is performed in the shape of a ring having a cylindrical inner face 71 and having a cylindrical outer face 72, wherein the axis 71a of the cylindrical inner face 71 is offset by a distance e against the axis 72a of the cylindrical outer face 72. Such a shape is also designated as eccentric ring. The distance of the axis 34a of the cylinder shaped body 34 from the axis 54a of the off center opening 54 of the output member 50, 50′ amounts also to a value e (FIGS. 1,6).

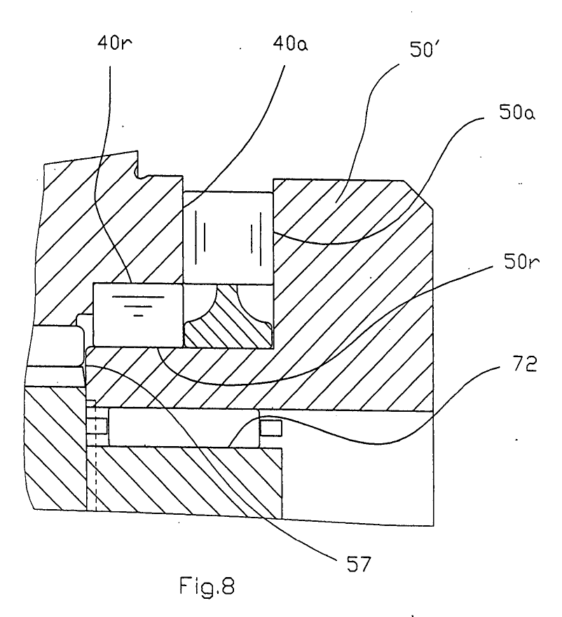

The rotatable support of the device 70 in the off center opening 54 of the output member 50, 50′ is furnished as a roller bearing with roller bodies 73 supported in a bearing cage. The rotary support of the cylindrical body 34 in the device 70 is also provided as a roller bearing. Rolling bodies 74 are furnished for this purpose and are supported in the bearing cage (FIGS. 1,2). Support faces 57 are formed at the front sides of the output members 50, 50′, which front sides are resting at the wheels 30 with external toothing, and wherein the wheels during their planetary motion are axially guided between the support faces 57. The support faces 57 simultaneously limit the axial forward feed of the cylinder cog 41b of the internal toothing 41 (FIG. 8).

Threaded bore holes 53 are furnished at least at one of the output members 50, 50′ at the outer front face for attachment of the gear drive at the object to be driven or at the frame of the facility, in which facility the gear drive is installed.

The second preferred embodiment of the gear drive according to the present Invention is shown in the FIGS. 1a and 2a as well as in FIG. 2b.

External toothings 91 are disposed at the two sides of the input shaft 9 and an inner group 92 is disposed in the inner opening for the connection of the drive motor. The external toothing 33 of the wheels 30 engages into the internal toothing 41 of the wheel 40. The number of teeth of the external toothing 33 of the wheel 30 is smaller as compared with the number of teeth of the internal toothing 41 of the wheel 40. The axis the 30a of the wheels 30 is offset by a distance e against the axis 42 of the wheel 40. The internal toothing 41 comprises grooves 41a with semi circular profile, wherein the cylinder cogs 41b are supported in the grooves 41a.

The wheels 30 with external toothing 33 exhibit off center passing through openings 32 aligned in axial direction and distributed uniformly over the circumference of the wheels 30. The wheels 30 are disposed between the output members 50, 50′. The output members 50, 50′ are connected to each other by way of cross members 52, wherein the cross members 52 are guided with play through the off center openings 32 of the wheels 30, such that the output members 50, 50′ form a mutually non-movable pair.

The cross elements 52 form an integral component of the output member 50′. In each case an opening and a bore hole are furnished at the front face of the cross member for in each case a screw 60 and a peg 61, which screw 60 and peg 61 solidly connect the output members 50, 50′ to each other.

The two output members 50, 50′ solidly connected to each other are rotatably supported in the wheel 40.

Each of the output members 50, 50′ exhibits are central opening 51 and a cylindrical radial outer face 50r. The input shaft 10 is rotatably supported in the central openings 51 of the output members 50, 50′ by way of roller members 13 and bearing tracks 11 disposed at the ends of the shaft 10. The rolling members 13 are disposed in a bearing cage.

Openings 54 of the output members 50, 50′ are disposed in the space between the central opening 51 and the radial face 50r of the output members 50, 50′, wherein the openings 54 are disposed at the equal distances to each other.

Off center axial faces 50a are formed at the outer side of the output members 50, 50′ at the side disposed toward the wheel 40.

The wheel 40 exhibits cylindrical radial inner faces 40r at the sides of the wheel 40 disposed toward the output members 50, 50′. In addition, axial circular ring faces 40a are formed at the outer front sides, which circular ring faces are aligned and directed perpendicular to the axis 42 of the wheel 40 with internal toothing 41. The cross distance of the axial faces 40a in the direction of the axis 42 essentially determines the thickness of the wheel 40 with internal toothing 41.

Cylinder shaped roller members 56 are disposed at two sides between the axial faces 40a, 50a and the output member 50, 50′, wherein the axes of the roller members 56 are aligned and directed perpendicular to the axis 42 of the wheel 40. The roller members 56 are supported in recesses 81′ of the bearing cage 80. The bearing cage 80 exhibits two front faces 80a and an inner face 80r, wherein the bearing cage 80 is rotatably supported with the inner face 80r on the cylindrical outer face of the output member.

Cylinder shaped roller elements 55 are disposed between the radial outer faces 50r of the output members 50, 50′ and the radial inner faces 40r of the wheel 40, wherein the axes of the roller elements 55 run parallel to the direction of the axis 42 of the wheel 40 with internal toothing 41.

The roller elements 55 are guided by a guide face formed of the front faces 80a of the bearing cage 80 and the guide face formed in the wheel 40 during rolling on the faces 50r and 40r.

A facility is disposed between each of the wheels 30 with external toothing and the resting output member 50, 50′, wherein the facility transforms the planetary motion of the wheel 30 with external toothing into a rotary motion of the output member 50, 50′. The facility comprises two cylinder shaped bodies 34 formed as cylinder tenons, wherein the cylindrical bodies 34 are distributed uniformly at the outer circumference of the front faces of the wheel 30 resting at the output member 50, 50′. The cylinder shaped bodies 34 are oriented in the direction of the axis 42 of the wheel 40 with internal toothing and are solidly connected to the wheel 30 with external toothing. The cylinder shaped bodies 34 are rotatably supported in the devices 70, wherein the devices 70 in turn are supported rotatably in the off center openings 54 of the output members 50, 50′.

The device 70 has the shape of a ring with a cylindrical inner face 71 and a cylindrical outer face 72, wherein the axis 71a of the cylindrical inner face is staggered by the distance e against the axis 72a of the cylindrical outer face 72—eccenter ring. The distance of the axis 34a of the cylinder shaped bodies 34 from the axis 54a of the off center openings 54 of the output member 50, 50′ also corresponds to the eccentricity e.

The rotatable support of the device 70 in the off center opening 54 of the output member 50, 50′ is again performed as a roller support bearing with roller bodies 73 supported in a bearing cage. The rotary support of the cylindrical bodies 34 in the device 70 is also performed as a roller bearing. Roller bodies 74 supported in a bearing cage are furnished for this purpose (FIG. 1a, 2a, 2b). Support faces 57 are formed at the front sides of the output members 50, 50′ resting at the wheels 30 with external toothing, wherein the wheels during their planetary motion are axially guided between the support faces 57. The support faces 57 at the same time limit the axial advance of the cylinder cog 41b of the internal toothing 41 (FIG. 2a).

The wheel 8 with the second external toothing 81 is non-rotatably connected to the device 70, wherein the wheel 8 engages with the first external toothing 91 of the input shaft 9 such that the axis of the wheel 8 with the second external toothing 81 is identical with the axis of the outer face 72 of the device 70 (FIG. 2b). The wheel 8 with the second external toothing 81 is connected to the device 70 by way of a groove connection.

The output bodies 50, 50′ are furnished with planar support faces 57 at the front sides resting at the wheels 30 with external toothing, wherein the wheels are axially guided during their planetary motion between the planar support faces 57. The support faces 57 secure the cylinder cogs 41b of the internal toothing 41 against an axial shifting (FIG. 2a).

One of the output members 50, 50′ is furnished with threaded bore holes 53 at the outer front face of the output member 50, 50′ for attachment of the gear drive at the driven object or at the frame of the facility, in which facility the gear drive is installed (FIG. 1a).

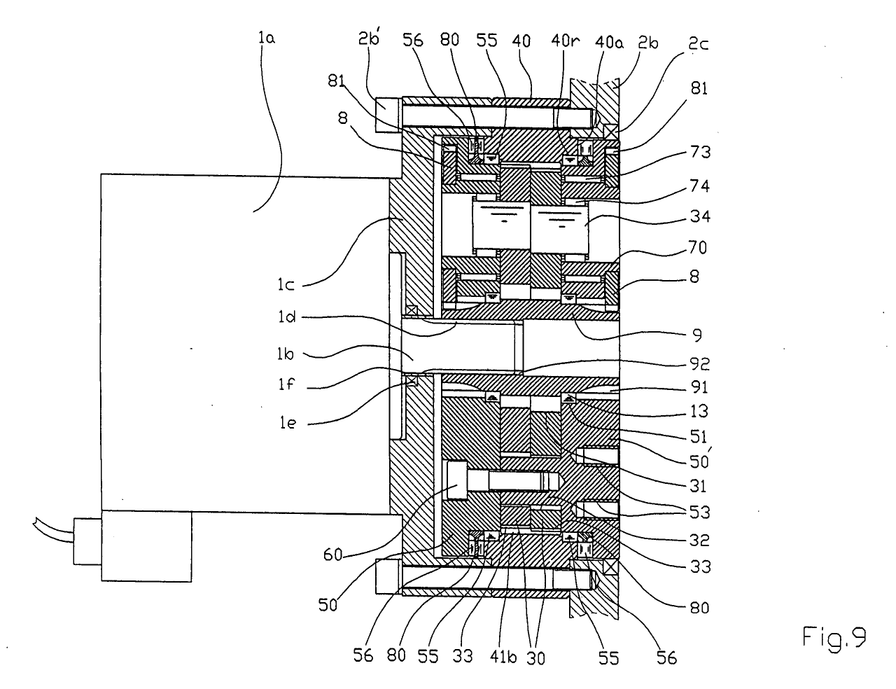

The connection of the drive motor 1a to the gear drive attached at the frame 2b and its sealings 2c is shown in FIG. 9. The drive motor 1a his furnished with outer grooves 1d at the end of the shaft 1b, wherein the outer groove 1d is inserted into the inner groove 92 of the input shaft 9 of the gear drive. The motor 1a is connected to the gear drive with the flange 1c, wherein the flange 1c is screwed to the gear drive with the aid of screws 2b′. The motor is sealed by way of a shaft seal 1e and a sealing ring 1f. The sealing of the gear drive 2c is embedded in the frame 2b and the outer circumference of the output member 50′ forms the sealing face for this seal.

It is emphasized that the off center chamber of the input member forming the lubricating chamber of the facility is sufficiently large and relatively well separated from the lubricating chamber of the remaining components. A contamination of the rotatably supported eccentric ring by microscopic abrasion products is prevented, wherein the abrasion products are generated during contact of the remaining functional faces of the gear drive mechanism.

The wheel with the external toothing can be furnished with at least one off center disposed axial passage opening.

The output member or the output members exhibit preferably a central opening and a cylindrical radial outer face. The input shaft can be rotatably supported in the central opening of the output members.

Preferably at least one additional off center opening is disposed in the region between the central opening and the outer roller face of the output member.

Preferably at least one of the output members is furnished at its outer side with an axially aligned circular ring face.

It is in addition conceivable to furnish the output members at the front sides resting at the wheels with external toothing with support front faces, wherein the wheel or the wheels are axially guided through the planetary motion of the wheel or the wheels between the support front faces. The guiding limits simultaneously the axial motion of the cogs in case the inner toothing is formed by cogs having a circular shaped cross-section and inserted into semi circular shaped grooves.

Threaded bore holes are disposed preferably at the outer front face at least one of the output members for the attachment of the gear drive at the driven object or at the frame of a facility in which the gear drive is installed.

In case two output members are furnished, then at least one wheel with external toothing is furnished between the output members. Here the output members can be connected to each other. The output members connected solidly to each other here can be rotatably supported in the wheel with the internal toothing. The connection of the output members can be provided and furnished with the aid of at least one cross member, wherein the across member passes with a play through the axial opening of the wheel with external toothing such that the output members form a mutually non-movable pair. The cross member forms either an integral component of at least one of the output members or is formed as a self-contained component, which component is connected solidly with that least one output member. A threaded bore hole for a screw and a bore hole for a pin can be formed at the front side of the cross member, wherein the output members are solidly connected to each other with the aid of the screw and the pin.

It will be understood that each of the elements described above, or two or more together, may also find a useful application in other types of transmission system configurations and rotary power processing procedures differing from the types described above.

While the invention has been illustrated and described as embodied in the context of a gear drive, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

### LIST OF REFERENCE NUMERALS

e distance of the input shaft axis from the crank pin axis
1a drive motor of the gear drive
1b motor shaft
1c flange connecting the motor to the gear drive
outer groove of the motor shaft
1e shaft seal of the motor
1f seal ring
2b frame to which the gear drive is attached
2b′ screws for attachment of the flange at the gear drive
2c gear drive seal
8 wheel with a second external toothing
9 input shaft with the first toothing
10 input shaft
10a axis of the input shaft
11 bearing tracks of the input shaft
12 rolling elements of the rotary bearing of the wheel with external toothing on the crank pin
12′ bearing cage of the roller rotary support of the wheel with external toothing
13 rolling members of the rotary bearing of the input shaft in the output member
14 inner groove for connecting the input shaft to the drive motor
17,17′ crank pin of the input shaft
17a,17′a crank pin axis of the input shaft
30 wheel with external toothing
31 central opening of the wheel with the external toothing
32 off center passing through axial opening of the wheel with the external toothing
33 external toothing
34 cylinder shaped body
34a axis of the cylinder shaped body
40 wheel with internal toothing
40a axial face of the wheel with the internal toothing
40r radial inner face of the wheel with the internal toothing
41 internal toothing
41a grooves with half-round profile of the wheel with the internal toothing
41b cylinder cogs of the internal toothing
42 longitudinal axis of the input shaft
50,50′ output member
50a axial face of the output member
50d cylindrical part of the cross member with end of thread
50m screw nut for attachment of the cross member in the output member
50r radial outer face of the output member
51 central openings of the output member
52 connection cross member of the output member
53 threaded bore holes for the connection of the gear drive
54 off center opening of the output member
54a axis of the off center opening of the output member
55 roller elements between the radial outer face of the output member and the radial inner face of the wheel with the internal toothing
56 roller members between the axial face of the output member and the axial face of the wheel with the internal toothing
57 support faces at the output members for the axial wheel guidance
58,50z threaded bore holes at the front side of the cross member
59 bore hole for the peg at the front side of the cross member
60 screw for connecting the output members
61 peg for connecting the output members
70 device of the arrangement, which device transforms the planetary motion of the wheel with external toothing
71 inner face of the device of the arrangement, which transforms the planetary motion of the wheel with external toothing
71a axis of the inner face of the device of the arrangement, which transforms the planetary motion of the wheel with external toothing
72 outer face of the device of the arrangement, which transforms the planetary motion of the wheel with external toothing
72a axis of the outer face of the device of the arrangement, which transforms the planetary motion of the wheel with external toothing
73 roller bodies of the rotatable roller bearing of the device in the off center opening of the output member
74 roller bodies of the rotatable polar bearing of the cylinder shaped body in the device
80 bearing cage of the rotatable roller bearing of the output member in the wheel with internal toothing
80a front face of the bearing cage of the rotatable roller bearing of the output member in the wheel with internal toothing
80r inner face of the bearing cage
81′ recess of the bearing cage of the rotatable roller bearing of the output member in the wheel with internal toothing
81 second external toothing
91 first toothing at the input shaft
92 section of the input shaft

1. A gear drive with that least one wheel (40) with internal toothing (41), with at least one output member (50, 50′) rotatable supported relative to the wheel (40) as well as an input shaft (10) with at least one eccentric section (17,17′) with an eccentricity (e), wherein a wheel (30) with external toothing (33) combing with the internal toothing and rotatable supported on the eccentric section (17,17′), wherein in case of two output members (50, 50′) there is disposed at least one wheel (30) between the output members (50, 50′), as well as a facility disposed between the wheel (30) and the output member (50, 50′), wherein the facility transforms the planetary motion of the wheel (30) into a rotary motion of the output member, characterized in that the facility exhibits at least one cylindrical body (34) extending in axial direction of the wheel (30), wherein the body (34) is rotatably supported in a device (70),
wherein the body (34) is operationally connected to the wheel (30) or, respectively, the output member (50, 50′),
wherein the device (70) is rotatably supported in an opening (54) of the output member (50, 50′) or, respectively, of the wheel (30), and
wherein the axis (34a) of the body (34) is disposed at a distance corresponding to the eccentricity (e) from the axis (54a) of the opening (54).

2. The gear drive according to claim 1 wherein the parts of the facility are shape matchingly connectable to each other.

3. The gear drive according to claim 1 wherein the peg shaped body (34) disposed at a distance relative to the longitudinal axis (42) of the input shaft (10) is protruding into the opening (54).

4. The gear drive according to claim 1 wherein the device (70) is formed as a hollow cylinder.

5. The gear drive according to claim 4 wherein the device (70) exhibits the shape of a sleeve, wherein the sleeve fills without play the space between the body (34) and the opening (54).

6. The gear drive according to claim 1 wherein the outer enveloping and the inner enveloping of the device (70) is cylindrical, wherein the axis (54a) of the opening (54) coincides with the axis (72a) of the outer face (72) of the device (70) and
wherein the distance of the axis (72a) of the outer face (72) of the device (70) from the axis (71a) of the cylindrical inner enveloping (71) corresponds to the eccentricity (e).

7. The gear drive according to claim 1 wherein several and preferably two, three, four, five, or six bodies (34) are furnished, wherein the bodies (34) are distributed around the longitudinal axis (42) of the input shaft (10) and wherein the bodies (34) are disposed in operational connection with a corresponding number of devices (70).

8. The gear drive according to claim 1 wherein the axial length of the bodies (34) as well as the axial length of the device (70) are selected such that they correspond approximately to the thickness of the output member (50).

9. The gear drive according to claim 1 wherein the connection between the bodies (34) and the coordinated devices (70) are obtained by plug connections in axial direction.

10. The gear drive according to claim 1 wherein at least one axial roller bearing is disposed at least between the plane parallel front sides of the output member (50) and of the wheel (30).

11. The gear drive according to claim 1 wherein the device (70) exhibits the shape of an eccentric ring shaped sleeve and wherein the device (70) is disposed in the space between the body (34) and the opening (54) and wherein in each case a roller bearing is disposed between the body (34) and the device (70) and/or between the device (70) and the opening (54).

12. The gear drive according to claim 1 wherein the eccentric section (17,17′) of the input shaft (10) includes at least one cylinder shaped crank pin parallel staggered relative to the longitudinal axis (42) of the input shaft (10) by the eccentricity (e), wherein the diameter of the crank pin corresponds at least to the diameter of the drive shaft plus doubled the value of eccentricity (e).

13. The gear drive according to claim 1 wherein the input shaft (9) exhibits at least one section (92) with an external toothing (91), wherein the external toothing (91) combs are gear wheel (8) connected to the device (70), wherein the axis of the gear wheel (8) corresponds to the axis (54a) of the opening (54), wherein the device (70) is disposed in the opening (54).

14. The gear drive according to claim 1 wherein the output member (50) is rotatably supported on the front side at the wheel (40) with the internal toothing (41).

15. The gear drive according to claim 14 wherein bearing tracks are furnished at least at the axial faces of the output member (50) and of the wheel (40) with internal toothing (41).

16. A gear drive comprising
an input shaft (10) having at least one eccentric section (17,17′) with an eccentricity (e);
a wheel (30) with external toothing (33) rotatable supported on the eccentric section (17,17′);
a wheel (40) with internal toothing (41) combing with the external toothing;
a first output member (50) rotatable supported relative to the wheel (40);
a second output member (50′) rotatable supported relative to the wheel (40);
wherein the wheel (30) with the external toothing (33) is disposed between the first output body (50) and the second output member (50′);
a cylindrical body (34) extending in axial direction of the wheel (30) with the external toothing, wherein the body (34) is operationally connected to the wheel (30) with the external toothing (33) or, respectively, the first output member (50), a device (70) rotatably supporting the cylindrical body (34), wherein the device (70) is rotatably supported in an opening (54) of the first output member (50) or, respectively, of the wheel (30) with the external toothing (33);
a facility including the cylindrical body (34), including the device (70) and disposed between the wheel (30) with the external toothing (33) and the first output member (50), wherein the facility transforms a planetary motion of the wheel (30) with the external toothing (33) into a rotary motion of the output member (50),
an axis (34a) of the body (34) disposed at a distance corresponding to the eccentricity (e) from an axis (54a) of the opening (54).
